(19) United States
(12) Patent Application Publication
(10) Pub. No.: US 2005/0193349 A1
(43) Pub. Date: Sep. 1, 2005

(54) Image display system and information processing apparatus

(76) Inventors: Fuminori Sato, Ohta-ku (JP); Tohru Murayama, Ohta-ku (JP)

Correspondence Address: JORDAN AND HAMBURG LLP, 122 EAST 42ND STREET, SUITE 4000, NEW YORK, NY, 10168, US

(21) Appl. No.: 11/069,374

(22) Filed: Mar. 1, 2005

(30) Foreign Application Priority Data
Mar. 1, 2004 (JP) 2004-056515

(51) Int. Cl. G06F 17/00

(52) U.S. Cl. 715/782

(57) ABSTRACT

The coordinate indicating objects are cross-shaped and aligned between the ball and cup. The virtual space has X axis from left to right, upward Y axis and Z axis toward depth direction. The coordinate indicating objects are arranged in a manner of check pattern on the X-Z coordinate. The Y-coordinate are set on the ground of course. The inclination indicating objects moves in descent direction between a pair of the coordinate indicating objects in a speed determined by the inclination value of the coordinate indicating objects adjacent in X or Z direction, that is, a difference of the Y-coordinate of the coordinate indicating objects. Therefore, clear expression is possible of inclination of inclined planes etc. without deteriorating natural atmosphere of a virtual space.

### BACKGROUND OF THE INVENTION

1. Field of the Invention

The present invention relates to an image display program and an information processing apparatus capable of expressing condition of inclined planes.

2. Prior Art

A topography is expressed in three dimension for example in a golf game, in order to express undulations of a geographical feature such as a golf course. A player cannot grasp delicate inclinations only by the expressed three dimensional image, that will be grasped by the player in a real golf playing. So, natural atmosphere of golf playing is to be expressed.

Therefore, in the golf game of the Patent Gazette No. 3386803, grid lines are shown on inclined planes in a landscape viewed by a player's eyes. Particles are moved between adjacent grids in speed corresponding to inclination of the planes.

However, there is a tendency that the grid lines are shown more crowded along the depth direction of an image of usual three dimensional expression. In the golf game of the patent publication 1, it is uneasy to recognize the inclination because the particles are always shown regardless of the inclination. Further, the inclination is not clearly expressed, because the particles moves very slowly on gentle slopes and are not easily distinguished from stopped particles.

### SUMMARY OF THE INVENTION

The present invention is invented so as to solve such conventional problems and has an object to express inclination of inclined planes etc. clearly without deteriorating natural atmosphere of a virtual space.

The present invention is an image processing program executable by a computer for positioning an object and a view point in a three dimensional virtual space and for generating an image of said object viewed in a view direction from said view point, said image processing program comprising, a first step for setting a plurality of control points in a visual field corresponding to said view direction along a surface of said object arranged in said three dimensional virtual space, a second step for calculating an inclination value representing a height difference between two of said adjacent control points; a third step for judging whether said inclination value is more than a predetermined value or not; a fourth step for displaying an inclination indicating object showing that said surface of said object is inclined between said adjacent control points where said inclination value is judged to be more than said predetermined value; and a fifth step for executing said steps from first to fourth every when at least said view point or said view direction is changed.

Therefore, clear expression is possible of inclination of inclined planes etc. without deteriorating natural atmosphere of a virtual space.

The present invention is an image processing program executable by a computer for positioning an object and a view point in a three dimensional virtual space and for generating an image of said object viewed in a view direction from said view point, said image processing program comprising, a first step for setting a plurality of control points in a visual field corresponding to said view direction along a surface of said object arranged in said three dimensional virtual space, a second step for positioning an inclination indicating object for each said control point overlapping on said surface of said object between each said control point and said adjacent control point to said control point; a third step for calculating an inclination value representing a height difference between two of said adjacent control points, a fourth step for judging whether said inclination value is more than a predetermined value or not, a fifth step for changing said inclination indicating object from invisible to visible, which are positioned concerning said control points having said inclination value of more than said predetermined value, a sixth step for executing said steps from first to fourth every when at least said view point or said view direction is changed.

Therefore, clear expression is possible of inclination of inclined planes etc. without deteriorating natural atmosphere of a virtual space with omitting unnecessary indications.

The image processing program according to the present invention further comprises a step for moving said inclination indicating object from one of said control point to another said control point. said former control point being higher than said latter, on said surface of said object in said three dimensional virtual space. Therefore, the inclination direction is clear.

The image display program according to the present invention may further comprises a step for setting a speed corresponding to said inclination value and for moving said inclination indicating object in said speed set. Therefore, the inclination value is more clearly shown. Therefore, the inclination value is clearer.

In the image processing display program according to the present invention, said inclination indicating object may be of a length corresponding to said inclination value. Therefore, the inclination value is more clearly shown.

The present invention is an information processing apparatus comprising a CPU, a memory means for storing an image display program, an image processing means for executing said display program read from said memory medium under a control of said CPU and for generating an image data of an object positioned in a three dimensional virtual space viewed in a view direction from a view point, and a means for displaying an image on a display according to said image data from said image processing means, wherein said image processing means functions by said image display program executed, as a first means or positioning said object and said view point in said three dimensional virtual space; as a second means for newly positioning a plurality of control points on said surface of said object in a visual field corresponding to said view direction in said three dimensional virtual space every when at least one of said view point and said view direction is changed, as a third means for calculating an inclination value representing a height difference between two of said adjacent control points; as a fourth means for judging whether said inclination value is more than a predetermined value or not; as a fifth means for positioning an inclination indicating object showing that said surface of said object is inclined between said adjacent control points where said inclination value is judged to be more than said predetermined value; and as a sixth means for generating a display data applied for rendering said object in a visual field viewed from said view point and for displaying said inclination indicating object positioned corresponding to said control points of said inclination value more than said predetermined value.

Therefore, clear expression is possible of inclination of inclined planes etc. without deteriorating natural atmosphere of a virtual space.

The present invention is an information processing apparatus comprising a CPU, a memory means for storing an image display program, an image processing means for executing said display program read from said memory medium under a control of said CPU and for generating an image data of an object positioned in a three dimensional virtual space viewed in a view direction from a view point, and a means for displaying an image on a display according to said image data from said image processing means, wherein said image processing means functions by said image display program executed, as a first means or positioning said object and said view point in said three dimensional virtual space; as a second means for newly positioning a plurality of control points on said surface of said object in a visual field corresponding to said view direction in said three dimensional virtual space every when at least one of said view point and said view direction is changed, as a third means for positioning an inclination indicating object showing that said surface of said object is inclined between said two adjacent control points; and as a fourth means for calculating an inclination value representing a height difference between two of said adjacent control points; as a fifth means for judging whether said inclination value is more than a predetermined value or not; as a sixth means for changing said inclination indicating object from invisible to visible, which are positioned concerning said control points having said inclination value of more than said predetermined value; and as a seventh means for generating a display data applied for rendering said object in a visual field viewed from said view point and for displaying said inclination indicating object under visible condition.

Therefore, clear expression is possible of inclination of inclined planes etc. without deteriorating natural atmosphere of a virtual space.

### BRIEF DESCRIPTION OF DRAWINGS

FIG. 1 is a block diagram showing the first embodiment of an information processing apparatus according to the present invention,

FIG. 2 is a figure showing a display image shown in the information processing apparatus in FIG. 1,

FIG. 3 is a figure showing another display image shown in the information processing apparatus in FIG. 1. (Embodiment 1)

FIG. 4 is a figure showing further another display image shown in the information processing apparatus in FIG. 1,

FIG. 5 is a figure showing an inclined plane to be displayed in the information processing apparatus in FIG. 1,

FIG. 6-1 is a figure showing an arrangement of control points corresponding to the inclined plane,

FIG. 6-2 is a figure showing an arrangement of coordinate display object corresponding to the inclined plane,

FIG. 7 is a figure showing a movement vector indicator shown on the inclined plane,

FIG. 8 is a flowchart showing the first embodiment of an image display program executed by the information processing apparatus,

FIG. 9 is a flowchart showing the second embodiment of an image display program executed by the information processing apparatus,

FIG. 10 is a figure showing further another display image shown in the information processing apparatus of FIG. 1,

FIG. 11 is a figure showing further another display image shown in the information processing apparatus of FIG. 1, and

FIG. 12 is a figure showing further another display image shown in the information processing apparatus of FIG. 1.

### DETAILED DESCRIPTION OF THE INVENTION

Next the best mode of an image display program and an information processing apparatus according to the present invention is described with reference to the attached drawings.

### First Embodiment

[Information Processing Apparatus]

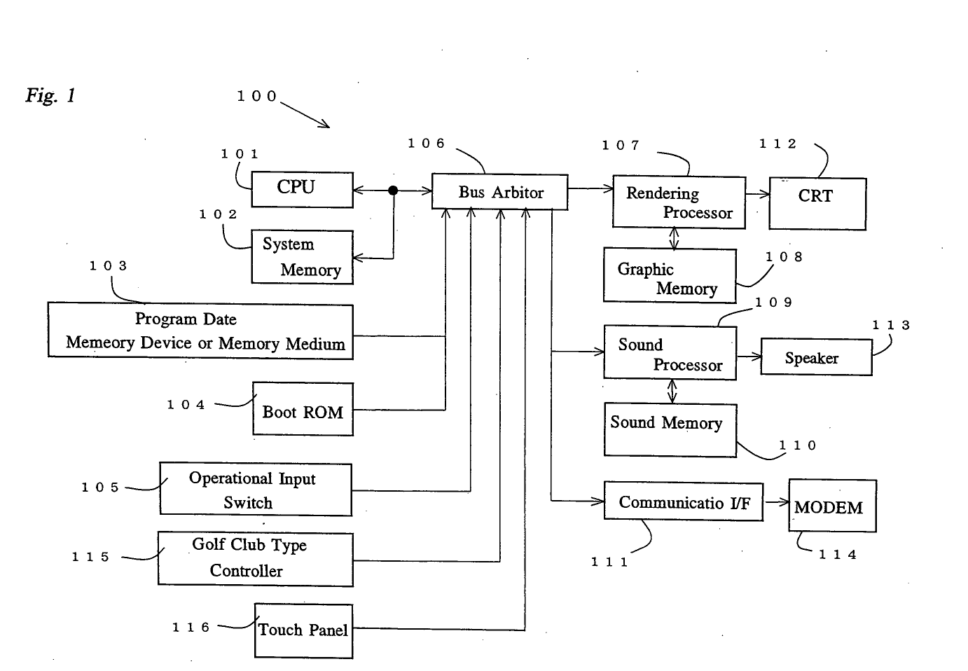

In FIG. 1, an information processing apparatus 100 includes a CPU 301 for controlling the apparatus totally, a boot ROM 304 which stores a program for starting up the information processing apparatus 100, and a system memory 302 which stores a program executed by the CPU 301 and data. The information processing apparatus 100 is applied to a personal computer, a game machine or a communication apparatus such as handy phone foe executing a golf game or other programs.

In the program executed by the CPU 301 and the data, there are included a program and data for controlling the game, and a program and data for generating images to be displayed.

In order to generate an image, polygon data having three dimensional local coordinate data for constructing objects to be shown is stored in the system memory. The objects are positioned by the CPU or a geometry processor (not shown) in a world coordinate system in the virtual space so that the local coordinate is transformed into the world coordinate system.

Further, a view point coordinate is set in the world coordinate system, which is generated along with the player's operation and game process. Objects viewed from the view point in a predetermined view angle is transformed into a view point coordinate system in which the view point is defined as an origin. The coordinate of the view points of the transformed objects are transmitted to a rendering processor 107.

The rendering processor 107 processes interpolation such as light source processing etc. of the transmitted view point coordinates of the objects. The rendering processor 107 gives details on surfaces of the objects by pasting texture data on the objects, which data is stored in a graphic memory 108. In order to project three dimensional solid object and to display the object in a display means 112, the object is transformed into two dimensional coordinate data, by projecting object (polygon) on a two dimensional plane. A two dimensional image is generated by rendering polygons in a priority order corresponding to shallowness in depth of Z-coordinate of the polygons. Then, the two dimensional image is generated and output to the display means 112 such as a CRT, liquid crystal display device etc.

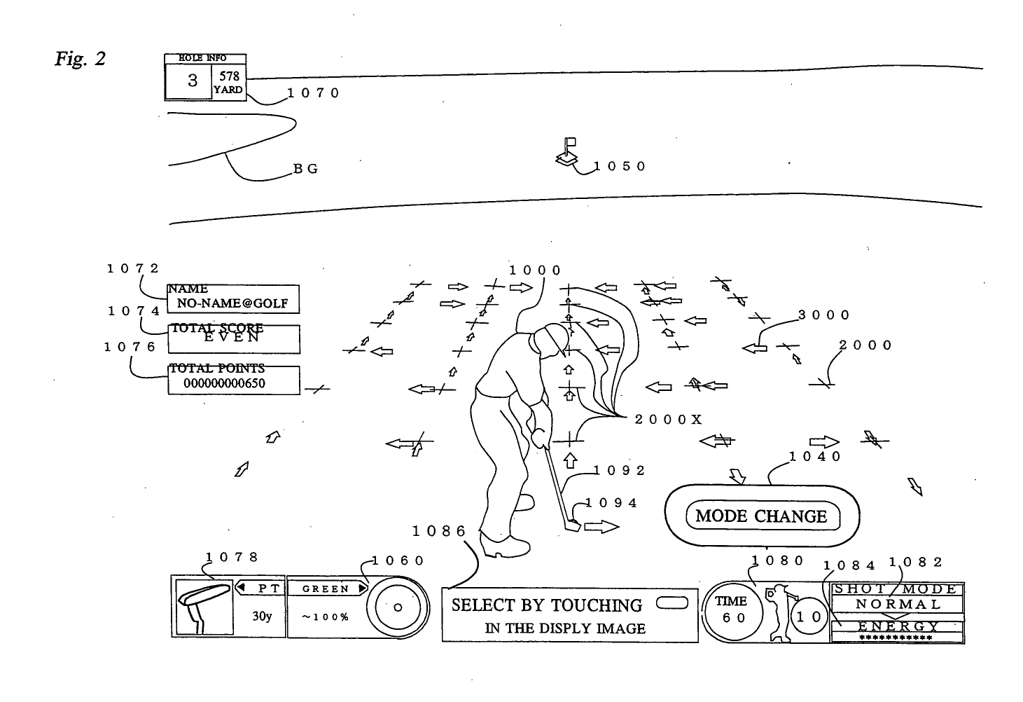

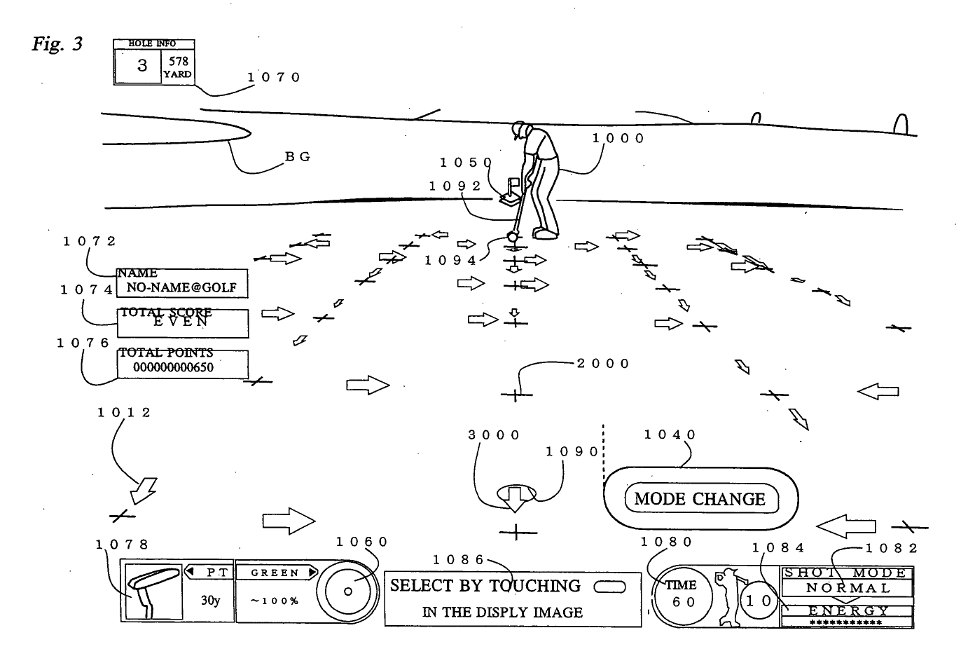

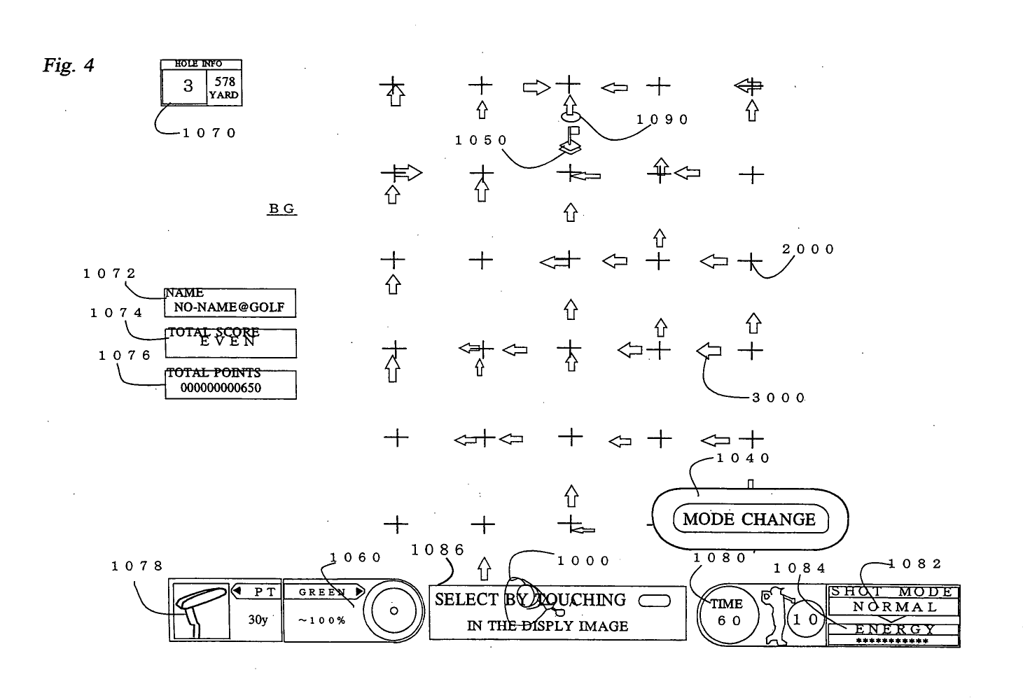

The information processing apparatus 100 is provided with a operation input switch 105, a golf club type controller 115, a touch panel 116 and other input means. A golf club 1092 (FIGS. 2 to 4) is operated by the golf club type controller 115.

The touch panel 116 is provided along a surface of the display means 112. Various input is possible by touching an indicator such as a finger on the touch panel 116 with changing touching information of the indicator, by changing touching pressure and touching position.

The information processing apparatus 100 is provided with a sound processor 109 for generating sound and a sound memory 110 for storing sound data generated. The sound processor 109 generates a digital sound signal according to data stored in the sound memory and outputs sound from a speaker 113 or headphone (not shown).

The information processing apparatus 100 is provided with a program data memory device and memory medium 103. Game program and data stored in these memory medium 103 are read into the system memory 102, graphic memory 108 and sound memory 110.

Information concerning the game is included in the data stored in the memory medium 103.

These memory medium may be a CD-ROM, DVD-R and other optically readable medium or a mask ROM, a flash memory and other electrically readable medium.

The information processing apparatus 100 is provided with a communication interface 111 and MODEM 114 and is connected through a LAN or MODEM 114 with a network IN.

The above components of the information processing apparatus 100 are connected to a bus, so that the program and data are controlled in inputting and outputting between the components by a bus arbiter 106.

As shown in FIGS. 2 to 4, an image of a player 1000, a club 1092 and a ball 1094 are arranged in a landscape BG of a golf course within a three dimensional virtual space is shown on the display means 112.

In the image, there are shown a mode change button 1040, an impact point setting icon 1060, specification 1070 of each hole, player name 1072, total score 1074, total point 1076, a club indicator 1078, a playing time indicator 1080, a shot indicator 1082, a player energy indicator 1084 and an explanation 1086 without overlapping with one another, at a front end of the image and in front of the BG and the player 1000.

The impact point setting icon 1060 sets a point of the ball 1094 to be hit by the club 1092, that is, the icon 1060 sets a lower position, right position, left position or upper position to be hit as well as a deviation of the point from the center.

A cup position indicating object 1050 is shown at a position on a straight line connecting the ball 1094 and the cup 1090 when the cup 1090 is behind the ball 1094 along a view direction from the player to the ball 1094. The position of the cup position indicating object 1050 is not defined by the three dimensional coordinate of the virtual space but by the two dimensional coordinate of the display image. The player 1000 can find the direction toward the cup 1090 even when the cup 1090 is concealed by such as the ground.

In the golf game, the cup 1090 (or the cup position indicating object 1050) is a target object. The ball 1094 is a moving object which is moved by the user aiming at the cup 1090. Therefore, a locasional relationship between the moving object 1094 and the target object 1090 (or 1050) should be especially clearly recognized. At least one coordinate indicating object 2000 (described later) is always aligned and shown on a straight line connecting the moving object 1094 and the target object 1090. So, the direction of the moving object 1094 to be moved (hit) is easily recognized and high operability is obtained.

When the cup (target object 1090) is not just in front of the ball (moving object 1094), the cup position indicating object 1050 is shown on a line connecting the view point and the cup 1090. However, the control may be also possible that the cup position indicating object 1050 is shown on a straight line connecting the view point and the cup regardless whether the cup 1090 is just in front of the ball 1094 or not.

Further, the cup position indicating object 1050 may be shown at a position with equal X-coordinate and higher Y-coordinate by a predetermined distance in the relative to the two dimensional display position of the cup 1090. When the view direction is changed, the cup position indicating object 1050 is shown with keeping this view condition.

In the specification 1070 of each hole, what number of hole is shown. In the hot indicator 1082, “NORMAL” is shown for example. In the player energy indicator 1084, energy held by the player 1000 is shown by a number of star marks. The energy indication is decreased according to player's unsuccessful play and number of strokes. If the energy becomes zero, the game is over. In the explanation, operations in the display image is shown.

[Outline of Inclination Indication]

In FIGS. 2 to 4, a situation of patting is shown, where the undulation is important. Therefore, the coordinate indicating objects 2000 and inclination indicating objects 3000 are shown for indicating the inclination of the ground.

The coordinate indicating objects 2000 are shown on the ground corresponding to predetermined coordinates of the horizontal plane. The positions of the coordinate indicating objects 2000 shown are previously calculated as “control points” described later.

The display images of FIGS. 2 to 4 are selectively switched by the mode change button 1040 or other operations.

The coordinate indicating objects 2000 are cross-shaped and aligned between the ball 1094 and cup 1090 corresponding to even intervals on the horizontal plane. The three dimensional virtual space has X axis from left to right, vertical Y axis and Z axis toward depth direction of the display image. The coordinate indicating objects 2000 are arranged in a manner of check pattern on the X-Z plane of a Y-coordinate of the height of the object surface such as the ground.

The inclination indicating objects 3000 moves between a pair of the coordinate indicating objects, in the descent direction and in a speed determined by the inclination value of the coordinate indicating objects 2000 adjacent in X or Z direction, that is, a difference of the Y-coordinate of the coordinate indicating objects 2000.

The adjacent coordinate indicating objects 2000 are apart from each other. There is a time that the inclination indicating object 3000 is shown without touching the coordinate indicating objects 2000 during the movement between the coordinate indicating objects 2000, so the inclination indicating object 3000 is clearly recognized.

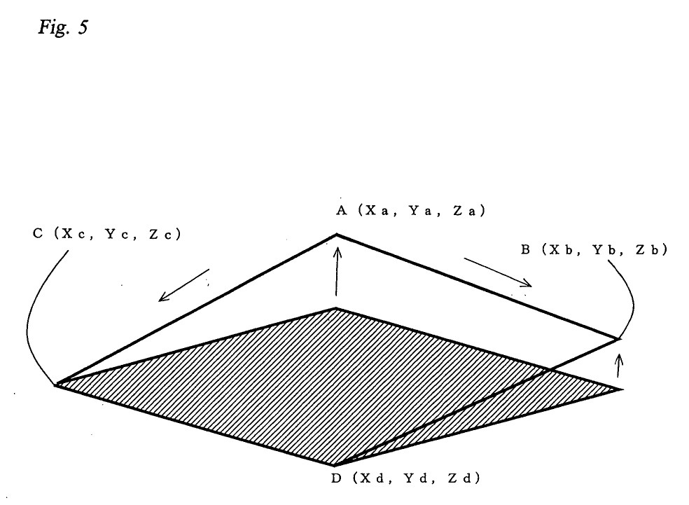

In FIG. 5, a rectangle ABCD (control points A, B, C, D) having vertexes on the coordinate indicating objects 2000 is supposed. The vertex B is higher than the horizontal side CD, and vertex A is higher than the vertex B. The coordinates of the vertexes A, B, C and D are A(Xa, Ya, Za), B(Xb, Yb, Zb), C(Xc, Yc, Zc) and D(Xd, Yd, Zd).

A projection of the rectangle ABCD on the horizontal plane is square, and Xa=Xc, Xb=Xd, Za=Zb, Zc=Zd, Xa−Xb=Xc−Xd and Za−Zc=Zb−Zd.

The coordinate indicating objects 2000 at the vertexes A and B are adjacent in the X direction to those at the vertexes C and D. The coordinate indicating objects 2000 at the vertexes A and C are adjacent in the Z direction to those at the vertexes B and D.

The coordinates Ya, Yb, Yc and Yd are Ya>Yb>Yc=Yd, if compared. In the game program, a descent inclination from the vertex A to B, a descent inclination from the vertex B to D and a descent inclination from the vertex A to C are judged.

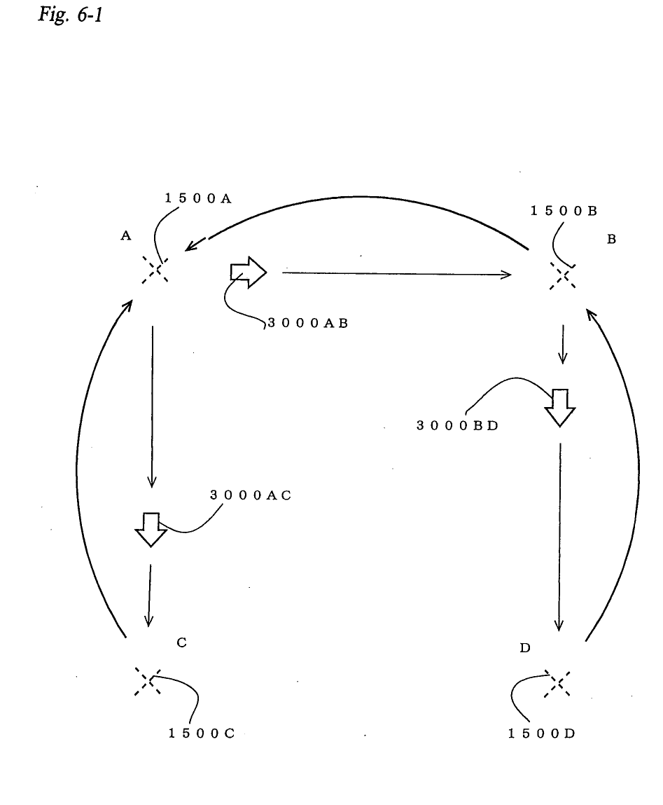

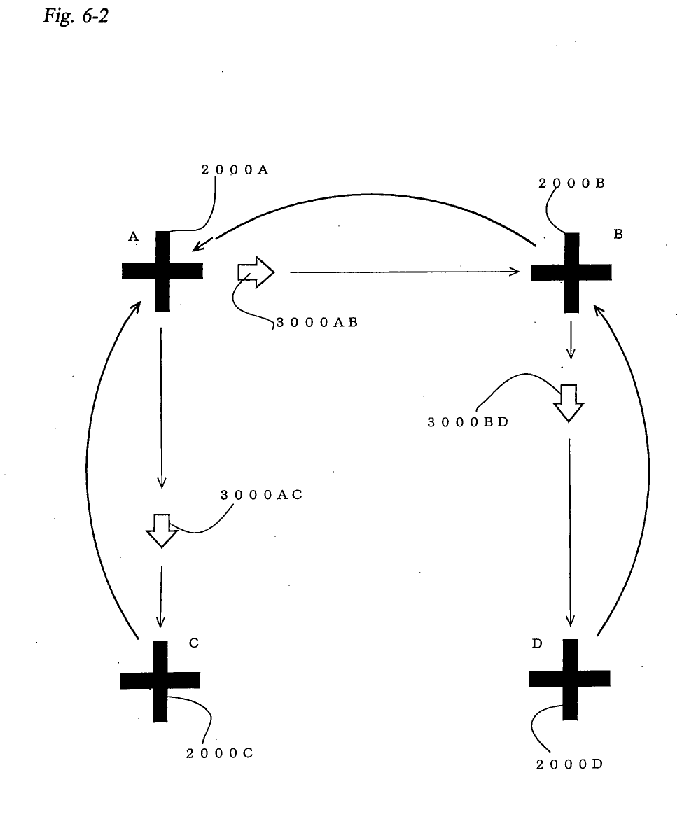

As shown in FIG. 6-1, the coordinate points of the vertexes A, B, C and D are defined as invisible control points 1500A, 1500B, 1500C and 1500D, respectively. As shown in FIG. 6-2, the coordinate indicating objects 2000A, 2000B, 2000C and 2000D are positioned on the control points 1500A, 1500B, 1500C and 1500D, respectively.

The inclination indicating object 3000AB is shown from the coordinate indicating object 2000A toward the coordinate indicating object 2000B, the inclination indicating object 3000BD is shown from the coordinate indicating object 2000B toward the coordinate indicating object 2000D, and the inclination indicating object 3000AC is shown from the coordinate indicating object 2000A toward the coordinate indicating object 2000C, according to the height difference of the control points 1500A, 1500B, 1500C and 1500D.

The inclination indicating objects 2000 for indicating value are not indispensable, when only the inclination is to be shown. In this case, displaying of the coordinate indicating object 2000 may be omitted.

Such display omission makes the process load lighter and the process speed higher.

The inclination indicating object 3000AB, 3000BD, 3000AC move in the direction of AB, BD and AC, respectively, in a speed proportional to the height difference (Ya−Yb), (Yb−Yd) and (Ya−Yc), respectively.

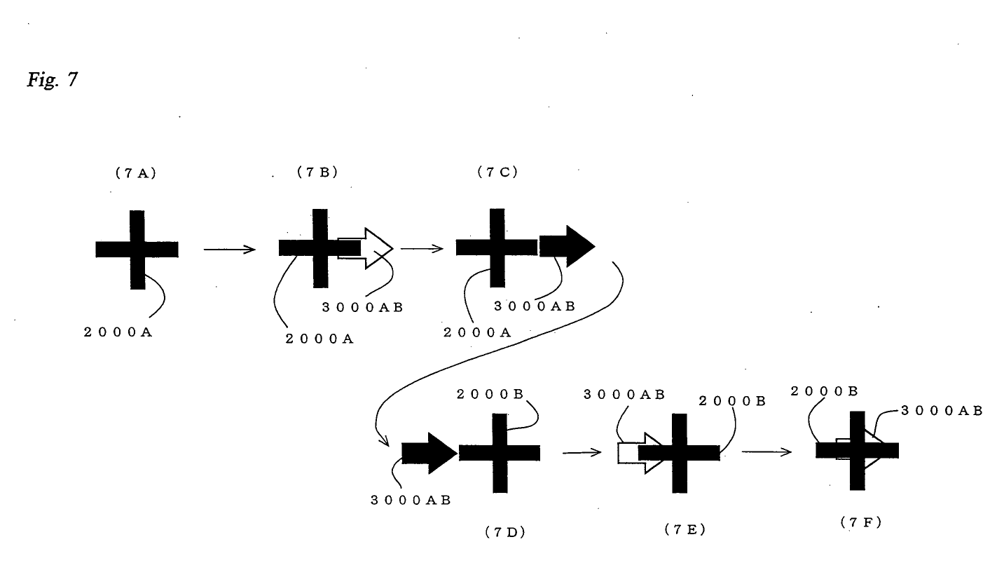

In FIG. 7, the inclination indicating object 3000AB is shown with changes from (7A) to (7F). In FIG. 7, the inclination indicating object 3000AB moving from the coordinate indicating object 2000A toward the coordinate indicating object 2000B is described representatively.

(7A) The inclination indicating object 3000AB appears with overlapping on the coordinate indicating object 2000A. The inclination indicating object 3000AB is substantially transparent.

(7B) The inclination indicating object 3000AB starts moving toward the coordinate indicating object 2000B. During movement, the inclination indicating object 3000AB becomes clearer and clearer. In 7B, a slightly clearer object 3000AB is shown by an outline arrow.

(7C) The inclination indicating object 3000AB further moves to the coordinate indicating object 2000B and shown clearer. In 7C, further clearer object is expressed by an opaque arrow such as black painted arrow.

When the inclination indicating object 3000AB approaches the coordinate indicating object 2000B, the inclination indicating object 3000AB becomes completely clear. In 7D, the clear inclination indicating object 3000AB is shown by black pained arrow similarly in 7C.

(7E) When overlapping of the inclination indicating object 3000AB and the coordinate indicating object 2000B occurs, the inclination indicating object 3000AB becomes more and more transparent. In 7E, the object is shown by an outline arrow similarly in 7B.

(7F) At the moment when the inclination indicating object 3000AB and the coordinate indicating object 2000B completely overlap, the inclination indicating object 3000AB is transparent similar to 7E. Then, the inclination indicating object 3000AB disappears and returns to 7A.

By the above display of the inclination indicating object 3000AB, the inclination value is indicated clearly as well as the rendering of the coordinate indicating objects 2000A and 2000B are not deteriorated.

[Image Display Program: Display of the Inclination Indicating Object According to the Movement Speed]

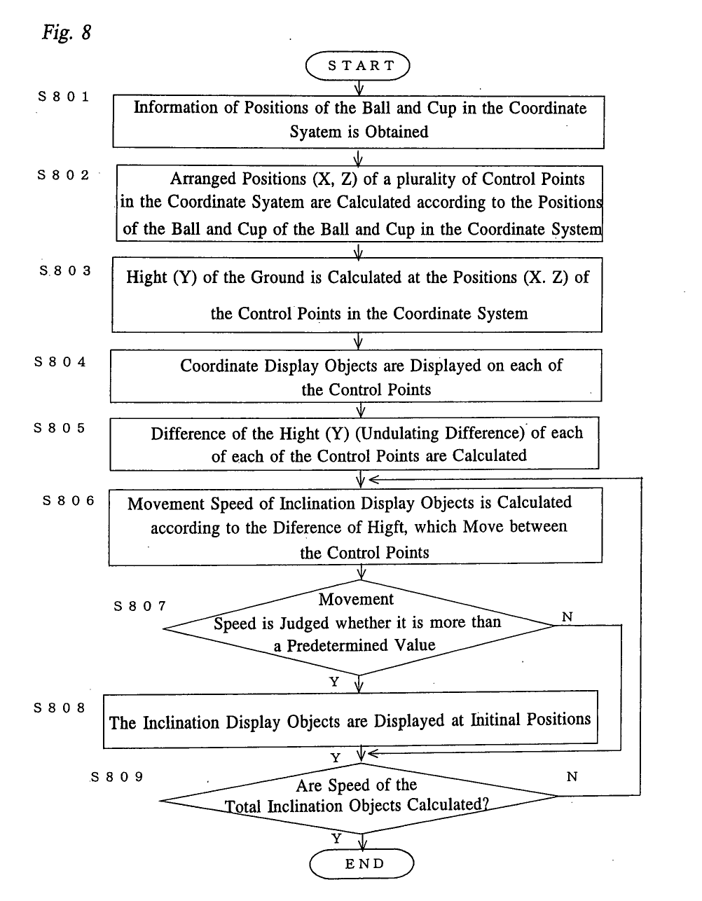

In FIG. 8, a game program is executed by following steps, which is the first embodiment of the image display program applied to the golf game and is executed by the information processing apparatus in FIG. 1.

Step S801: First, the coordinate (XB, YB, ZB) of the ball 1094 and the coordinate (XC, YC, ZC) of the cup 1090 are obtained. Then, the processing is advanced to the step S802.

Step S802: X-Z coordinate of a plurality of the control points 1500A, 1500B, 1500C and 1500D etc. are calculated in order to display he inclination indicating object 3000 between the ball 1094 and the cup 1090.

The X-Z coordinate of the control points from 1500A to 1500D are determined, for example, in a manner that a predetermined number of rows extending in the direction of the control points are aligned in the positive and negative direction of X-coordinate with constant interval. On each row, a predetermined number of control points are aligned between the coordinate of ZB and ZC.

In the above case, the control points are aligned at the determined coordinate between the ball and the cup. While, in a software without an objective object such as ball or cup, the view point, and intersections of view direction line and the ground or other objects are obtained, the control points may be arranged in a area defined by the intersections. Any arrangement may possible as long as the control points are arranged along the surface of the ground or other objects in the three dimensional virtual space in the visual field in the view direction.

Step S803: Next to the step S802, Y-coordinate is calculated corresponding to the height of the ground at the position of the control points.

Step S804: The coordinate indicating objects are shown on the control points calculated in the steps S802 and S803.

As mentioned above, the projection of the control points on the X-Z plane are arranged in a manner of check pattern in a rectangle which has opposite sides passing on the ball 1094 and the cup 1090, respectively. The Y-coordinate of each control point correspond to the height of the ground at each coordinate position so that the inclination value is clearly shown for eyesight in the display image.

The coordinate indicating objects 2000 are arranged on the control points in a manner of check pattern and reflect the Y-coordinate corresponding to the ground height at the coordinate positions. The undulation is clearly shown for eyesight in the display image.

Step S805: Next to the step S804, difference (height difference) between Y-coordinate of the adjacent control points along X or Y direction is calculated. Then, the inclination value between adjacent control points is calculated.

It can be judged which of the adjacent control points is higher with respect to Y-coordinate by comparing the Y-coordinate of the control points from the difference of the Y-coordinate.

Step S806: According to the inclination value calculated in the step S805, the moving speed calculated of the inclination indicating object 3000 moving between the control points. The moving speed is calculated by multiplying the inclination value by predetermined constants for X and Y direction, respectively. The constant for X and Y coordinate is determined according to a position of the view point.

The moving speed may be calculated according to a speed minimum “0” and a speed maximum “1” corresponding to the maximum 0 degree and the minimum 90 degree of the inclination value, respectively.

Step S807: One inclination indicting object 3000 is processed. It is judged whether the movement speed calculated in the step S806 of the inclination indicating object 3000 to be processed is more than a predetermined value or not. When the movement speed is more than the predetermined value, the processing is advanced to the step S808, otherwise, jumped to the step S809.

Preferably, the predetermined value is a movement speed of “0” or “nearly zero”.

Therefore, only the inclination indicating objects 3000 of rather high speed are shown, and the inclination indication is omitted at gentle or zero inclination value. The image construction is neat and clear, and the undulation is more clearly shown.

Step S808: The inclination indicating object 3000 to b processed is positioned at the initial point and the movement is started to be shown. The initial point is the middle of the adjacent coordinate indicating objects, the middle of the adjacent control points, the point on the coordinate indicating object of high in Y-coordinate direction or the position on the control point.

Step: It is judged whether the movement speed is calculated for the total inclination indicating objects 3000. If not processed inclination indicating objects 3000 remains, the processing is returned to the step S806, otherwise, the processing is immediately terminated.

[Image Display Program: Display of the Inclination Indicating Object According to the Height Difference]

Next, an embodiment of the image display program partially changed is described, which is executed by the information processing apparatus in FIG. 1.

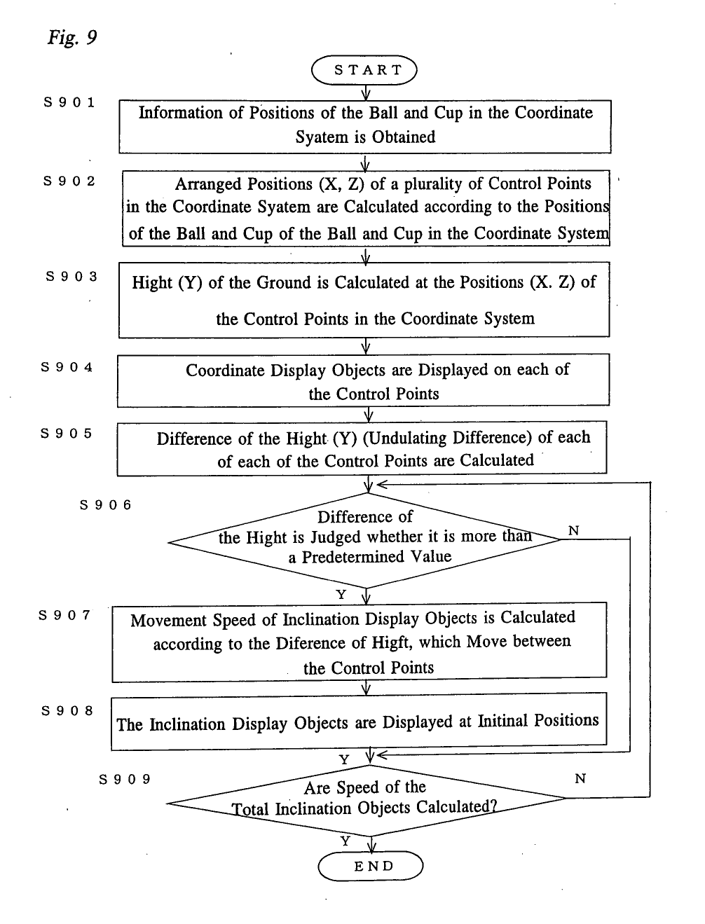

FIG. 9 is a flowchart of an example of the image display program.

In the image display program of FIG. 8, it is judged whether the inclination indicating object 3000 is visible or not according to the moving speed. While, in FIG. 9, the judgment is made according to height difference (difference in Y-coordinate) of adjacent control points.

In FIG. 9, since the steps S901 to 905, S908 and S909 are similar to the steps S801 to 805, S808 and S809, the explanations therefor are omitted.

In FIG. 9, the image display program is executed by the following steps.

Step S906: It judged whether the height difference calculated in the step S905 is more than a predetermined value or not. When the height difference is more than the predetermined value, the processing is advanced to the step S907, otherwise, jumped to the step S909.

Step S907: The movement speed of the inclination indicting object 3000 is calculated according to the height difference calculated in the step 905. Then, the step is advanced to the step S908.

In the image display program in FIG. 9, the calculation of the movement speed is omitted when the height difference is small. Therefore, the amount of calculation is decreased relative to that in the image display program of FIG. 8.

### Second Embodiment

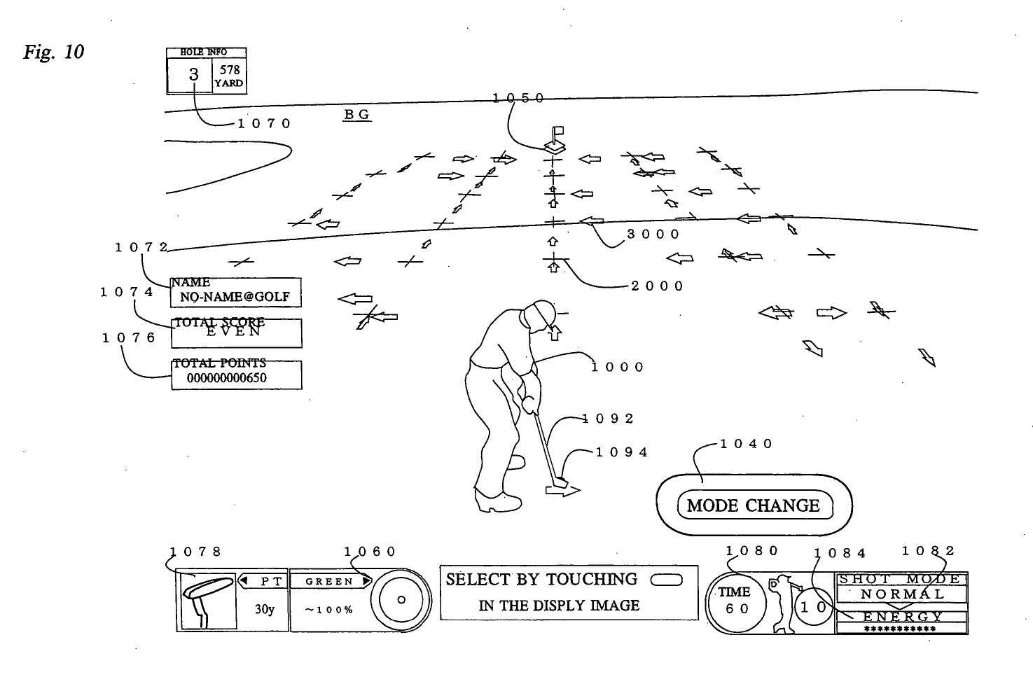

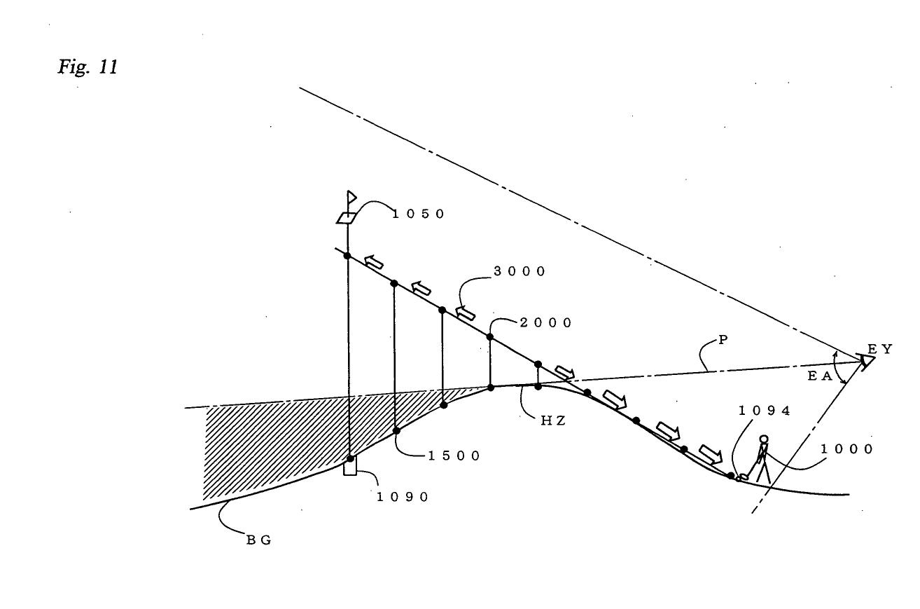

According to FIGS. 10 and 11, another method is described for controlling and setting the position of the coordinate indicating object and the inclination indicating object relative to the ground or other landscape BG (object).

As shown in FIG. 11, when the cup 100 exits remotely from the horizon HZ viewed from the view point EY, the cup 1090 cannot be seen from the view point EY because the cup 1090 drops within a blind spot (shown by hatching).

In such a case, the coordinate indicating object 2000 and the inclination indicating object 3000 are shown along the ground BG, and the inclination (gradient) behind the horizon HZ toward the cup 1090 cannot be confirmed, when the ball 1094 is moved from the position of the player character 1000 toward the cup 1090. Therefore, it is difficult to introduce the ball 1094 accurately to the cup 1090.

The position of the coordinate indicating object 2000 and the inclination indicating object 3000 are set as follows.

The control points 1500 are positioned relative to the object (ground) BG, and the step similar to the step in the embodiment 1 for generating the inclination indicating object 3000 is executed.

Next, with respect to the control points positioned on the surface of the object in the visual field EA viewed from the view point EY, it is judged whether the object exists between the coordinate positions of the view point and the control point.

The judgment manner is that coordinates on the straight line connecting view point EY and the control point 1500 are judged whether the coordinates are included in the coordinate of the surface or not.

When the control point 1500 is judged to be concealed behind the object BG by this judgment, the Y-coordinate of the control point 1500 is changed to a position where the control point 1500 is not interrupted by the ground BG viewed from the view point EY. The coordinate indicating object 2000 is shown at the position of the changed Y-coordinate.

Further, the inclination indicating object 3000 is shown between the control point of changed Y-coordinate and the adjacent control point whose Y-coordinate is changed or not changed.

By the processing above, the coordinate indicating object 2000 and the inclination indicating object 3000 corresponding to the control pints 1500 in the blind spot can be recognized by the player 1000.

The inclination indicating objects arranged in the virtual space, as in the above embodiment, may be invisible by a transparent display, a mask processing or other processing. The invisible inclination indicating objects are shown as an image by stopping the processing when the inclination value or the height difference is judged to be more than a predetermined value.

The calculation manner of the inclination such as the inclination value is not limited by the above embodiment. When the object surface such as the ground is constructed by polygons for example, a step may be executed for calculating a normal vector of a polygon at the control point as the inclination value. When the object surface is expressed by a nth order function of NURBS curved surface or line, the inclination value can be calculated by executing the calculation step of differentiating the nth order function at the control point.

The coordinate indicating object 2000 and the inclination indicating object are expressed by the cross and the arrow, respectively. Any other symbols and shapes are applicable.

It is also possible that the inclination indicating objects are once shown corresponding to all of the control points when the control points are arranged in the three dimensional virtual space. After the inclination value is calculated, it is judged whether the inclination value is more than a predetermined value or not. The corresponding inclination objects are displayed when the inclination value is more than the predetermined value. Or the display i controlled such that the inclination indicating objects are set to be transparent and change to be opaque when the inclination value i more than the predetermined value.

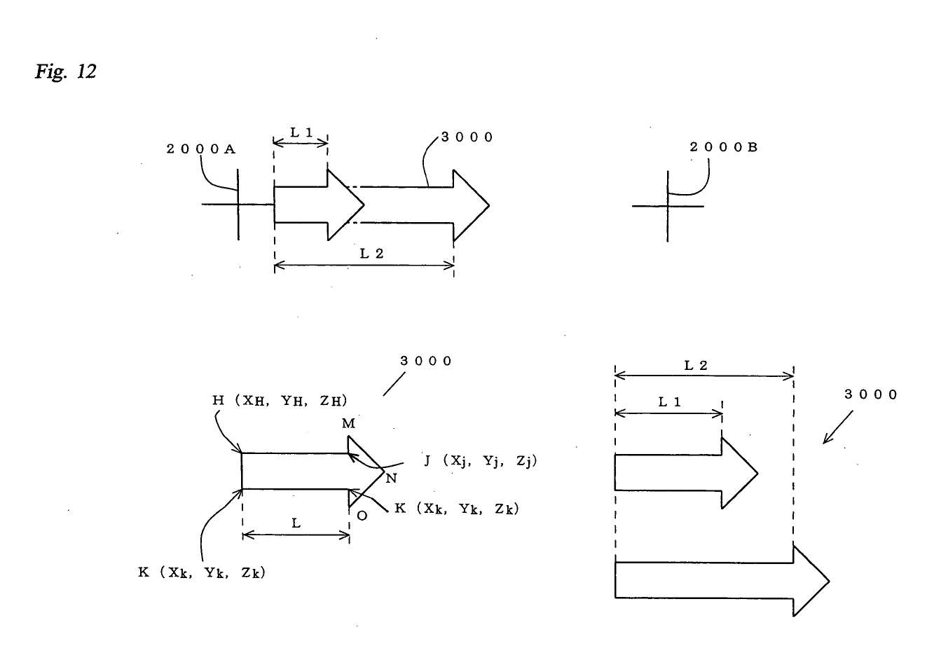

The inclination indicating object may be changed in shape for example in length corresponding to the inclination value or the height difference, in stead of the movement in a speed corresponding to the inclination value or the height difference, as in FIG. 12.

Therefore, the continuous calculation is unnecessary of the appearance position of the inclination indicating object and a effect is obtained that the processing load of the computer is lightened.

In FIG. 12, an inclination indicating object 3000 between the coordinate indicating objects 2000A and 2000B is constructed by a polygon having apexes (H, I, J, K, M, N, O), and the apexes J, K, M, N, O are changed in X-coordinate relative to the apexes H and I so that the length of the length of the coordinate indicating object is changed from L to L1 to L2.

Therefore, the inclination indicating object is changed in length corresponding to the inclination value or the height difference.

The information processing apparatus is not limited to the construction in FIG. 1. A general purpose computer, a handy computer, a handy phone or other information processing terminal may be applied to a game processing terminal such as a game machine.

When a game system according to the present invention is constructed by a general purpose computer as a game machine, an executable program by the computer is read into the general purpose computer, which program includes program codes. By the program codes, the general purpose computer executes each step of the program for executing the game.

The program by which the general purpose computer executes the game is read from a ROM incorporated within the general purpose computer, from a memory medium readable for the general purpose computer or from a server through a network.

Further, the present invention is applicable to any game in which a moving object is moved toward a target object on a inclined surface. For example, the present invention is applied to a strategy simulation game in which the game process is changed according to a lay of the land or an inclination of a surface of an appearing object as a geographical effect, and a fighting or action game in which hit judgment of a player character and an opponent character or movement peed of the character is geographically changed. Further, the present invention is applicable not only to games but also to any image display such as CAD etc. in which inclination display is needed.

Advantages

According to the present invention, since unnecessary indications are effectively omitted, clear expression is possible of inclination of inclined planes etc. without deteriorating natural atmosphere of a virtual space.

1. An image processing program executable by a computer for positioning an object and a view point in a three dimensional virtual space and for generating an image of said object viewed in a view direction from said view point, said image processing program comprising:
a first step for setting a plurality of control points in a visual field corresponding to said view direction along a surface of said object arranged in said three dimensional virtual space;
a second step for calculating an inclination value representing a height difference between two of said adjacent control points;
a third step for judging whether said inclination value is more than a predetermined value or not;
a fourth step for rendering an inclination indicating object showing that said surface of said object is inclined between said adjacent control points where said inclination value is judged to be more than said predetermined value; and
a fifth step for executing said steps from first to fourth every when at least said view point or said view direction is changed.

2. An image processing program executable by a computer for positioning an object and a view point in a three dimensional virtual space and for generating an image of said object viewed in a view direction from said view point, said image processing program comprising:
a first step for setting a plurality of control points in a visual field corresponding to said view direction along a surface of said object arranged in said three dimensional virtual space;
a second step for positioning an inclination indicating object for each said control point overlapping on said surface of said object between each said control point and said adjacent control point to said control point;
a third step for calculating an inclination value representing a height difference between two of said adjacent control points;
a fourth step for judging whether said inclination value is more than a predetermined value or not;
a fifth step for changing said inclination indicating object from invisible to visible, which are positioned concerning said control points having said inclination value of more than said predetermined value; and
a sixth step for executing said steps from first to fourth every when at least said view point or said view direction is changed.

3. An image processing program according to claim 1, further comprising a step for moving said inclination indicating object from one of said control point to another said control point. said former control point being higher than said latter, on said surface of said object in said three dimensional virtual space.

4. An image processing program according to claim 3, further comprising a step moving said inclination indicating object in a speed corresponding to said inclination value.

5. An image processing program according to claim 1 wherein said inclination indicating object is of a length corresponding to said inclination value.

6. A memory medium in which said image processing program according to any one of claims 1 to 5 is stored for execution on a computer.

7. An information processing apparatus comprising a CPU, a memory means for storing an image display program, an image processing means for executing said display program read from said memory medium under a control of said CPU and for generating an image data of an object positioned in a three dimensional virtual space viewed in a view direction from a view point, and a means for displaying an image on a display according to said image data from said image processing means, wherein said image processing means functions by said image display program executed,
as a first means or positioning said object and said view point in said three dimensional virtual space;
as a second means for newly positioning a plurality of control points on said surface of said object in a visual field corresponding to said view direction in said three dimensional virtual space every when at least one of said view point and said view direction is changed,
as a third means for calculating an inclination value representing a height difference between two of said adjacent control points;
as a fourth means for judging whether said inclination value is more than a predetermined value or not;
as a fifth means for positioning an inclination indicating object showing that said surface of said object is inclined between said adjacent control points where said inclination value is judged to be more than said predetermined value; and
as a sixth means for generating a display data applied for rendering said object in a visual field viewed from said view point and for displaying said inclination indicating object positioned corresponding to said control points of said inclination value more than said predetermined value.

8. An information processing apparatus comprising a CPU, a memory means for storing an image display program, an image processing means for executing said display program read from said memory medium under a control of said CPU and for generating an image data of an object positioned in a three dimensional virtual space viewed in a view direction from a view point, and a means for displaying an image on a display according to said image data from said image processing means, wherein said image processing means functions by said image display program executed,
as a first means or positioning said object and said view point in said three dimensional virtual space;
as a second means for newly positioning a plurality of control points on said surface of said object in a visual field corresponding to said view direction in said three dimensional virtual space every when at least one of said view point and said view direction is changed,
as a third means for positioning an inclination indicating object showing that said surface of said object is inclined between said two adjacent control points; and
as a fourth means for calculating an inclination value representing a height difference between two of said adjacent control points;
as a fifth means for judging whether said inclination value is more than a predetermined value or not;
as a sixth means for changing said inclination indicating object from invisible to visible, which are positioned concerning said control points having said inclination value of more than said predetermined value; and
as a seventh means for generating a display data applied for rendering said object in a visual field viewed from said view point and for displaying said inclination indicating object under visible condition.
